(19) United States
(12) Patent Application Publication
(10) Pub. No.: US 2026/0205445 A1
(43) Pub. Date: Jul. 16, 2026

(54) DUMMY-BASED PRIVACY PROTECTION METHOD AND SYSTEM BASED ON SEMANTIC RELEVANCE OF MOVEMENT PATH

(71) Applicant: GUIZHOU UNIVERSITY OF FINANCE AND ECONOMICS, Guiyang (CN)

(72) Inventors: Hai LIU, Guiyang (CN); Hongye PENG, Guiyang (CN); Ying TANG, Guiyang (CN); Hongfa DING, Guiyang (CN)

(73) Assignee: GUIZHOU UNIVERSITY OF FINANCE AND ECONOMICS, Guiyang (CN)

(21) Appl. No.: 19/450,784

(22) Filed: Jan. 16, 2026

(30) Foreign Application Priority Data
Jan. 16, 2025 (CN) 202510069237.3

(51) Int. Cl. H04L 9/40

(52) U.S. Cl. CPC H04L 63/0421

(57) ABSTRACT

A dummy-based privacy protection method and system based on semantic relevance of a movement path belongs to the technical field of privacy protection. The dummy-based privacy protection method method and system uses a neural network to learn spatiotemporal and semantic features between locations on a real movement path of a user, combines a transition probability between location sequences, quantifies an impact of query time on the spatiotemporal and semantic features between the locations, and provides a dummy-based privacy protection scheme based on semantic relevance of a movement path. Theoretical analysis and extensive experiments show that this scheme can efficiently help the user generate a dummy sequence whose spatiotemporal and semantic features are indistinguishable from those of a real location sequence, thereby effectively protecting location privacy of a requesting user.

### CROSS REFERENCE TO THE RELATED APPLICATIONS

This application is based upon and claims priority to Chinese Patent Application No. 202510069237.3, filed on Jan. 16, 2025, the entire contents of which are incorporated herein by reference.

### TECHNICAL FIELD

The present disclosure relates to the technical field of privacy protection, and, in particular, to a dummy-based privacy protection method and system based on semantic relevance of a movement path.

### BACKGROUND

With the development of mobile intelligent devices and networks, location-based services (LBSs) have become an indispensable part of people's daily life. However, while enjoying the convenience brought by LBSs, a user is also exposed to a risk of personal privacy leakage. This is because, when sending an LBS request, the user needs to provide a location-based service provider (LSP) with location information that may contain personal privacy. As a result, the LSP may collect and misuse the location information submitted by the user, thereby obtaining the user's personal privacy.

To address the above problem, researchers worldwide have proposed various location privacy protection methods, such as dummy-based methods, K-anonymity-based methods, differential privacy-based methods, cryptography-based methods, coordinate transformation-based methods, and the like. Among these existing location privacy protection methods, the dummy-based location privacy protection method is widely adopted because it does not rely on a third party, does not require a complex cryptographic technique, and can make the user obtain an accurate query result.

Nevertheless, existing dummy-based location privacy protection schemes fail to measure semantic relevance between location sequences of a real query from a holistic perspective when a requesting user continuously uses the LBS. However, in real life, a next visited location is affected not only by a previous visited location but also by other historical locations visited during a current trip. This is because in daily life, location sequences in a movement path of the user often exhibit close semantic relevance. If the user directly adopts the existing dummy-based location privacy protection schemes for privacy protection, the LSP can identify some dummies based on inter-location semantic relevance in the movement path formed by location set sequences submitted by the user. In this way, a location privacy protection level of the user is reduced, and even a real location of the user can be directly identified. For example, it is assumed that a user continuously initiates LBS requests at time points t₁, t₂, . . . , tₙ₊₁ on a workday. In this case, dummies of the user in a hospital, a shop, and a bar at the time points tₙ₋₁, tₙ, and tₙ₊₁ are generated by using the existing dummy-based location privacy protection schemes. From a perspective of semantic relevance between adjacent locations alone, a movement path “hospital→shop” formed from the time point tₙ₋₁ to the time point to and a movement path “shop→bar” formed from the time point tₙ to the time point tₙ₊₁ are reasonable. However, from a perspective of a location sequence, a movement path “hospital→shop→bar” formed from the time point tₙ₋₁ to the time point tₙ₊₁ is unreasonable in terms of customary relevance. In this case, the LSP can infer with a high probability that the movement path is dummy and identify each location in the movement path as a dummy. Therefore, the existing dummy-based location privacy protection schemes cannot effectively protect location privacy of the user.

The dummy-based location privacy protection scheme is first proposed by Kido et al. based on an obfuscation principle, and its core idea is that the user sends a location set containing the real location of the user and K-1 dummies to the LSP, such that the LSP can identify the real location of the user with a maximum probability of 1/K, where K represents a quantity of privacy protection demands of the user. It is pointed out by Lu et al. that if dummies generated by the user are concentrated in a specific region, the location privacy of the user cannot be effectively protected. To solve this problem, they introduce a concept of location dispersion, making a distance between each dummy generated by the user and the real locations as far as possible. However, the above scheme does not consider background knowledge possessed by the LSP. The LSP can eliminate some implausible dummies, for example, in the middle of an intersection or a lake, based on the background knowledge such as geographic information, thereby effectively reducing the privacy protection level of the user. Therefore, Xia Xingyou et al. design a privacy protection system structure based on a semi-trusted third-party server, which generates a dummy using a historical query probability and a Stackelberg game model. In addition, it is pointed out by Zhang et al. that a time factor should be incorporated into the generation of the dummy when the location privacy of the user is protected by using the dummy. It is found by Liu et al. through research that when the user frequently sends LBS requests in a same region, it should be ensured that a query frequency of a region in which the dummy is generated is consistent with that of a region in which the real location is located. Parmar and Rao introduce a query region into the generation of the dummy to prevent both the real location of the user and the generated dummy from being centered in a corresponding query region.

Nevertheless, the above scheme still fails to effectively protect the location privacy of the user when the user sends the LBS request. To address this problem, Liu et al. propose a dummy-based privacy protection scheme based on spatiotemporal relevance. They measure relevance between real locations of the user in continuous queries from both time and space dimensions, thereby providing more effective protection for the location privacy of the user during continuous usage of the LBS. Hara et al. propose a user preference-based dummy generation scheme, which ensures that continuous query regions of the user contain points of interest (POIs) that align with a user preference. Moreover, Tang et al. predict a real location of the user when the user sends an LBS query in the future, to pre-generate dummies for all future queries at initial time points of continuous queries. This method ensures that a dummy movement path formed by location sets submitted by the user is indistinguishable from a real movement path of the user. Nevertheless, the above scheme cannot effectively protect the location privacy of the user when the user sends an LBS query outside the predicted location.

However, all the above schemes do not consider the semantic similarity between the real location and the dummy during the generation of the dummy. If the above schemes are directly adopted for protecting the location privacy of the user, the LSP can utilize the semantic similarity to identify some dummies and even directly identify the real location.

### Dummy-Based Privacy Protection Scheme Based on Location Semantics

Chen and Shen are the first to introduce a concept of location semantics into the generation of the dummy. It is found from their research that if the generated dummy has an identical semantic attribute with the real location of the user, the LSP can still infer the personal privacy of the user. To solve this problem, they measure semantic similarities of different locations based on a distance between nodes in a location semantic tree. A distance between different locations in the semantic tree is maximized to ensure that the generated dummy and the real location of the user are semantically diverse, thus protecting the location privacy of the user. However, this scheme tends to generate a dummy that can be easily identified, for example, in the middle of a lake or at a summit of a mountain. To solve this problem, Yang et al. combine query entropy with the location semantics and employ a multi-objective optimization algorithm to achieve the following two objectives: (1) A historical query count of the generated dummy is the same as that of the real location of the user. (2) Under a premise of ensuring that query counts of various locations are as equal as possible, the generated dummy and the real location are semantically diverse. To prevent the generated dummy and the real location from being concentrated in a region, Wang Jie et al. incorporate the concept of location dispersion into the generation of the dummy. As a result, while ensuring that the generated dummy and the real location are semantically diverse and have a same query count, these locations (including both the dummy and the real location) are as far apart as possible. However, if the generated dummy and the real location are geographically too dispersed, the LSP can utilize a city map to identify some dummies. To address this problem, Tadakaluru et al. consider time at which the user sends the LBS request and divides a map region using a Voronoi diagram, thereby preventing the generated dummy from being geographically too far away from the real location.

The dummy-based privacy protection scheme based on location semantics only takes into account the semantic similarity between the generated dummy and the real location of the user, but ignores semantic sensitivity of different locations. If the above scheme is directly adopted, the LSP can still identify some dummies based on the location semantics. To solve this problem, Li and Wu measure semantic sensitivity of a location by using a knowledge graph, and Min et al. employ a differential privacy mechanism to protect semantic sensitivity of both the generated dummy and the real location of the user.

The dummy-based privacy protection scheme based on location semantics is only suitable for protecting the location privacy of the user in a single discrete query. In practical applications, however, the user often sends LBS requests continuously. Therefore, Bindschaedler and Shokri propose that when dummies are generated for continuous queries of the user, both a spatiotemporal similarity and a semantic similarity between adjacent real locations should be considered. Xing et al. point out that when the user sends the LBS requests continuously, some real locations have low sensitivity, and thus only real locations with high location sensitivity need to be protected. To achieve this goal, they propose a dummy replacement algorithm, which uses the generated dummy to replace a high-sensitivity real location in the continuous queries.

The above analysis shows that the prior art has the following problems and defects:
(1) Attackers, and even the LSP itself, acquire and misuse user location information, resulting in serious user data leakage and privacy leakage.
(2) The existing dummy-based location privacy protection schemes fail to fully consider the background knowledge possessed by the LSP. As a result, the LSP can utilize relevant prior knowledge to identify some dummies and even directly infer the real location.
(3) The existing dummy-based location privacy protection schemes do not fully consider spatiotemporal relevance and semantic relevance between the generated dummy and a real location sequence of the user, failing to ensure indistinguishability of the generated dummy.
(4) When the user uses the LBS continuously, the existing dummy-based location privacy protection schemes fail to fully consider a feature of a movement trajectory from a holistic perspective when generating the dummy, resulting in semantic conflicts between some dummies and a historical trajectory of the user.

Therefore, it can be concluded that the existing dummy-based location privacy protection schemes cannot effectively protect the location privacy of the user.

### SUMMARY

In order to address the problems existing in the prior art, the present disclosure provides a dummy-based privacy protection method based on semantic relevance of a movement path.

The present disclosure is implemented as follows: A dummy-based privacy protection method based on semantic relevance of a movement path includes:
step 1, extracting spatiotemporal and semantic features of each location sequence in a movement path of a user by using a long short-term memory (LSTM) network, introducing an attention mechanism to assign different weights based on inter-location relevance in a real location sequence of the user, and generating candidate dummies that have same spatiotemporal and semantic features as the real location sequence of the user; and
step 2, taking a historical movement path of the user as a reference, calculating a transition probability between location sequences, and quantifying an impact of current query time on the spatiotemporal and semantic features of the generated candidate dummies, and screening the generated candidate dummies, such that a remaining dummy after the screening is capable of effectively protecting location privacy of the user.

Further, the generating candidate dummies that have same spatiotemporal and semantic features as the real location sequence of the user includes:
(1) enabling the generated dummies to be consistent with a real location of the user in terms of relevance to the location sequence, learning and extracting the features of the location sequence in the movement path of the user by using a neural network, and generating a dummy semantic type that conforms to a movement feature; and
(2) acquiring the candidate dummies based on a predicted dummy semantic type, obtaining, through the screening, a dummy that meets a location transition probability screening condition, and ensuring that a probability of transition from a historical location point on the historical movement trajectory of the user to each of the generated dummies is greater than a preset threshold.

Further, a method for the screening is as follows:
first determining a dynamic location transition probability screening threshold, which is determined by elements in a transition probability set of a different location when the different location serves as a semantic state before the transition, where the dynamic location transition probability screening threshold is a percentile of the set and is affected by a time factor, where a longer time interval between two location points leads to a smaller value of the dynamic location transition probability screening threshold, and probabilities of transition from each point on the historical movement path of the user to the candidate dummies all need to be greater than the dynamic threshold; scoring all the candidate locations based on a historical transition probability; and finally outputting top K-1 dummies with a highest score.

Another objective of the present disclosure is to provide a dummy-based privacy protection system based on semantic relevance of a movement path, including:
a generation module configured to extract spatiotemporal and semantic features of each location sequence in a movement path of a user by using an LSTM network, introduce an attention mechanism to assign different weights based on inter-location relevance in a real location sequence of the user, and generate candidate dummies that have same spatiotemporal and semantic features as the real location sequence of the user; and
a screening module configured to take a historical movement path of the user as a reference, calculate a transition probability between location sequences, and quantify an impact of current query time on the spatiotemporal and semantic features of the generated candidate dummies, and screen the generated candidate dummies, such that a remaining dummy after the screening is capable of effectively protecting location privacy of the user.

Another objective of the present disclosure is to provide a computer device. The computer device includes a memory and a processor, where the memory stores a computer program, and the computer program is executed by the processor to perform the steps of the dummy-based privacy protection method based on semantic relevance of a movement path.

Another objective of the present disclosure is to provide a computer-readable storage medium, storing a computer program. The computer program is executed by a processor to perform the steps of the dummy-based privacy protection method based on semantic relevance of a movement path.

Another objective of the present disclosure is to provide an information data processing terminal. The information data processing terminal is configured to implement the dummy-based privacy protection system based on semantic relevance of a movement path.

In combination with the above technical solutions and the technical problems to be solved, the technical solutions to be protected by the present disclosure have the following advantages and positive effects:
Firstly, the present disclosure uses a neural network to learn spatiotemporal and semantic features between locations on a real movement path of a user, combines a transition probability between location sequences, and further quantifies an impact of query time on the spatiotemporal and semantic features between the locations. Based on this, a dummy-based privacy protection scheme based on semantic relevance of a movement path is provided. Theoretical analysis and extensive experiments show that the scheme can efficiently help the user generate a dummy sequence whose spatiotemporal and semantic features are indistinguishable from those of a real location sequence, thereby effectively protecting location privacy of a requesting user.

Secondly, auxiliary evidences for inventiveness of claims of the present disclosure are further reflected in the following important aspects:
(1) The expected income and commercial value of the technical solutions of the present disclosure after transformation are as follows:
With the popularization of mobile terminal devices and the rapid development of smartphones, an LBS, as a service integrating mobile communication, the Internet, spatial positioning, and big data technologies, has shown strong growth momentum in recent years. According to the White Paper on the Development of China's Satellite Navigation and Location Services Industry (2023) recently released by the Global Navigation Satellite System (GNSS) and LBS Association of China, the overall output value of China's satellite navigation and location services industry reached 536.2 billion RMB in 2023, with an increase of 7.09% compared with that in 2022. However, while the LBS brings great convenience to people's daily lives, a risk of user privacy leakage also increases, which undoubtedly hinders further development of the LBS. The present disclosure can protect location privacy of the user from being leaked when the user uses the LBS, and has high expected income and commercial value.
(2) The technical solutions of the present disclosure fill the technical gap in the industry throughout the world:
The technical solutions of the present disclosure technically make up for deficiencies in a traditional dummy-based location privacy protection scheme, and provide an innovative solution to a privacy leakage problem caused when the user continuously uses the LBS. The technical solutions of the present disclosure use the neural network to learn the spatiotemporal and semantic features between the locations on the real movement path of the user, combine the transition probability between the location sequences, and precisely quantify the impact of the query time on the spatiotemporal and semantic features between the locations. In this way, the spatiotemporal and semantic features of the generated dummy sequence are indistinguishable from those of the real location sequence of the user, thereby effectively protecting the location privacy of the requesting user.
(3) Whether the technical solutions of the present disclosure solve the technical problem that people have been eager to solve but have not been successfully solved:
The technical solutions of the present disclosure optimize a problem of failure of existing location privacy protection technologies when the user continuously sends a plurality of LBS requests within a period of time in daily life. In a scenario of continuously sending LBS requests, location sequences in a movement path of the user usually have close semantic relevance, that is, a next visited location of the user is affected not only by a previous location but also by other historical locations visited in a current trip. Therefore, the present disclosure uses the neural network to learn spatiotemporal and semantic features between the location sequences in the movement path of the user, and uses an inter-location transition probability as a measurement standard to ensure that the dummy sequence whose spatiotemporal and semantic features are indistinguishable from those of the real location sequence is generated.
(4) The technical solutions of the present disclosure overcome the following technical prejudice:
Among existing location privacy protection methods, a dummy-based location privacy protection method has a major technical problem to be solved, namely, how to make a generated dummy more consistent with a real trajectory of the user, which makes it difficult for an attacker to identify the generated dummy and thus protects a real location of the user. Although existing dummy-based research schemes have paid attention to an impact of inter-location relevance on credibility of the dummy, most of them are limited to relevance between adjacent locations, and rarely focus on relevance between non-adjacent locations, especially semantic relevance between the non-adjacent locations. The present disclosure takes the historical movement path of the user as the reference, uses the neural network to extract a feature of the movement path of the user, adjusts a feature weight through the attention mechanism, and finally performs the screening based on a location transition probability to obtain a reasonable dummy, thereby effectively protecting user privacy when the user uses the LBS.

Thirdly, the existing technical problems solved by the technical solutions of the present disclosure in industrial applications are mainly concentrated on privacy protection of a mobile user, especially location privacy protection. In the prior art, commonly-used privacy protection methods such as dummy generation, obfuscation strategies, and anonymity technologies often fail to effectively balance spatiotemporal relevance and semantic consistency of locations. Specifically, the generated dummy sequence usually lacks relevance to the real movement trajectory of the user, resulting in limited effectiveness in protecting the location privacy of the user, and is even cracked by the attacker through spatiotemporal feature analysis or semantic matching. In addition, the existing methods lack in-depth analysis of historical movement data and a user behavior pattern when generating the dummy. As a result, the generated dummy is unreasonable or is inconsistent with an actual behavior habit of the user, thereby further reducing the effectiveness in protecting the location privacy of the user.

The significant technological advancements of the present disclosure are mainly reflected in the following aspects:
1. Introduction of the LSTM network and the attention mechanism: Compared with the traditional methods, the present disclosure uses the LSTM network to extract spatiotemporal features in a location sequence of the user, which can effectively capture a dynamic change rule in the movement path of the user. Through the attention mechanism, different weights are assigned to different locations in the location sequence, which enhances the inter-location relevance and makes spatiotemporal and semantic features of the generated dummy closer to those of the real path. The introduction of such a deep learning model significantly improves rationality of the generated dummy and difficulty of the privacy protection.
2. Screening combined with the historical movement data: After generating the dummy, the present disclosure calculates the transition probability between the location sequences by referring to the historical movement data of the user, and performs the screening to obtain a dummy that conforms to the user behavior pattern. In this way, the dummy is similar to the real location sequence, and can maintain consistency with spatiotemporal features of a user behavior, thereby effectively resisting a location privacy attack. Compared with a method for generating a dummy by solely relying on a statistical approach in the prior art, the present disclosure significantly improves authenticity of the dummy by introducing the neural network and analyzing the historical data.
3. Dynamic optimization of the spatiotemporal and semantic features: In a real-time query scenario, the present disclosure dynamically adjusts the spatiotemporal and semantic features by analyzing an impact of a current time point on the candidate dummies, making the generated dummy sequence more consistent with a current movement state of the user. This technological progress makes the dummy sequence more flexible, and significantly enhances a privacy protection capability in a dynamic query environment, thereby further improving strength of the location privacy protection.
4. Enhancing a user privacy protection effect and improving user experience: Traditional privacy protection methods often compromise the user experience when pursuing a good privacy protection effect, for example, make a feature of the dummy deviate too much from that of the real location, resulting in reduced service quality for the user. However, through reasonable simulation of the spatiotemporal and semantic features, the present disclosure can improve the privacy protection effect without significantly affecting normal application experience of the user, thereby achieving a balance between the privacy protection and a system function.

In summary, by innovatively combining a deep learning technology, historical data analysis, and semantic optimization, the present disclosure has achieved significant technological progress in the location privacy protection, solved the problems of poor relevance in the generation of the dummy and a limited privacy protection effect in the prior art, and can effectively enhance privacy security of the user in industrial applications.

### BRIEF DESCRIPTION OF THE DRAWINGS

FIG. 1 is a flowchart of a dummy-based privacy protection method based on semantic relevance of a movement path according to an embodiment of the present disclosure;

FIG. 2 is a structural block diagram of a dummy-based privacy protection system based on semantic relevance of a movement path according to an embodiment of the present disclosure;

FIG. 3 is a schematic diagram of a user path according to an embodiment of the present disclosure;

FIG. 4 is a diagram of a system structure according to an embodiment of the present disclosure;

FIG. 5 is a diagram of POI classification according to an embodiment of the present disclosure;

FIG. 6 is a structural diagram of a scheme according to an embodiment of the present disclosure;

FIG. 7 is a flowchart of generating a dummy semantic type according to an embodiment of the present disclosure;

FIG. 8 is a structural diagram of an input layer according to an embodiment of the present disclosure;

FIG. 9 is a structural diagram of a neural network according to an embodiment of the present disclosure;

FIG. 10 is a distribution diagram of a time interval between locations on a path according to embodiment of the present disclosure;

FIG. 11 shows similarities between an original transition probability set and different conditional probability sets according to an embodiment of the present disclosure;

FIGS. 12A and 12B show losses of a training set and a validation set according to an embodiment of the present disclosure;

FIGS. 13A and 13B show accuracy rates of a training set and a validation set according to an embodiment of the present disclosure;

FIG. 14 shows a relationship between a privacy protection demand and an anonymization success rate according to an embodiment of the present disclosure;

FIG. 15 shows a relationship between a quantity of generated semantic types and an anonymization success rate according to an embodiment of the present disclosure;

FIG. 16 shows a relationship between a screening threshold and an anonymization success rate according to an embodiment of the present disclosure;

FIG. 17 shows a quantity of paths meeting a location transition probability according to an embodiment of the present disclosure;

FIG. 18 shows privacy protection strength of different schemes during continuous usage of an LBS according to an embodiment of the present disclosure;

FIG. 19 compares average calculation latencies for generating an anonymity set according to an embodiment of the present disclosure; and

FIG. 20 shows average calculation latencies for generating a dummy under different quantities of dummy semantic types according to an embodiment of the present disclosure.

### DETAILED DESCRIPTION OF THE EMBODIMENTS

To make the objectives, technical solutions, and advantages of the present disclosure clearer and more comprehensible, the present disclosure will be further described below in detail in conjunction with embodiments. It should be understood that the specific embodiments described herein are merely intended to explain the present disclosure but not to limit the present disclosure.

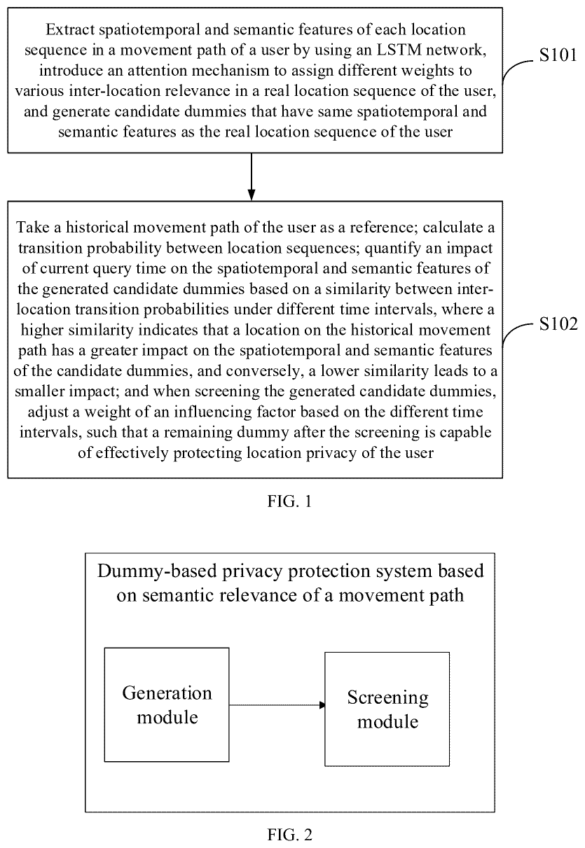

As shown in FIG. 1, a dummy-based privacy protection method based on semantic relevance of a movement path according to an embodiment of the present disclosure includes the following steps:
S101: Spatiotemporal and semantic features of each location sequence in a movement path of a user are extracted by using an LSTM network, an attention mechanism is introduced to assign different weights based on inter-location relevance in a real location sequence of the user, and candidate dummies that have same spatiotemporal and semantic features as the real location sequence of the user are generated.
S102: A historical movement path of the user is taken as a reference, a transition probability between location sequences is calculated, an impact of current query time on the spatiotemporal and semantic features of the generated candidate dummies are quantified, and the generated candidate dummies are screened, such that a remaining dummy after the screening is capable of effectively protecting location privacy of the user.

A working principle of the dummy-based privacy protection method based on semantic relevance of a movement path in this embodiment of the present disclosure is mainly divided into two steps: extracting location features of the user through a deep learning model, and screening dummies through probability calculation. First, in the step S101, the LSTM network is used to extract the spatiotemporal and semantic features of each location sequence in the movement path of the user. The LSTM network has a capability of processing time-series data and can capture a pattern that a movement trajectory of the user changes over time. The attention mechanism is combined to assign different weights to different locations to ensure that the generated dummies have similar spatiotemporal and semantic features to a real location.

Next, the attention mechanism is introduced to further enhance relevance between location sequences. The attention mechanism assigns a different weight to each location based on contextual information of the location, so as to highlight a more important location on a real movement path of the user. In this way, a generated dummy sequence is not only similar to the real path of the user but also has higher fidelity in terms of relevance to a specific location. This makes a movement feature of the dummy sequence more consistent with that of the real location, thereby increasing difficulty of privacy protection.

In the step S102, a system takes the historical movement path of the user as the reference, and evaluates spatiotemporal and semantic features of each candidate dummy at a current time point by calculating the transition probability between the location sequences. The transition probability represents a possibility of the user moving from one location to another location, and these candidate locations are evaluated in combination with a time factor. In this way, the system can dynamically perform the screening based on the current query time and the historical movement path of the user to obtain a dummy whose feature is closest to that of the real path, so as to ensure rationality and authenticity of the dummy.

Finally, candidate dummies obtained after transition probability calculation and spatiotemporal feature analysis are further screened, leaving a dummy that can effectively confuse a tracker. The dummy obtained after the screening can maximally protect actual location privacy of the user without affecting user experience, and it is ensured that the dummy has highly similar spatiotemporal and semantic features to the real path, ultimately achieving an effect of improving the privacy protection.

That candidate dummies that have same spatiotemporal and semantic features as the real location sequence of the user are generated includes:
(1) The generated dummies are enabled to be consistent with the real location of the user in terms of relevance to the location sequence, the features of the location sequence in the movement path of the user are learned and extracted by using a neural network, and a dummy semantic type that conforms to a movement feature is generated.
(2) The candidate dummies are acquired based on a predicted dummy semantic type, a dummy that meets a location transition probability screening condition is obtained through the screening, and it is ensured that there is a high probability of transition from a historical location point on the historical movement trajectory of the user to each generated dummy.

A method for the screening in this embodiment of the present disclosure is as follows:
A dynamic location transition probability screening threshold is first determined, which is determined by elements in a transition probability set of a different location when the different location serves as a semantic state before the transition. The dynamic location transition probability screening threshold is a percentile of the set and is affected by the time factor, where a longer time interval between two location points leads to a smaller value of the dynamic location transition probability screening threshold, and probabilities of transition from each point on the historical movement path of the user to the candidate dummies all need to be greater than the dynamic threshold. All the candidate locations are scored based on a historical transition probability, and finally top K-1 dummies with a highest score are output.

As shown in FIG. 2, a dummy-based privacy protection system based on semantic relevance of a movement path according to an embodiment of the present disclosure includes:
a generation module configured to extract spatiotemporal and semantic features of each location sequence in a movement path of a user by using an LSTM network, introduce an attention mechanism to assign different weights to various inter-location relevance in a real location sequence of the user, and generate candidate dummies that have same spatiotemporal and semantic features as the real location sequence of the user; and
a screening module configured to take a historical movement path of the user as a reference, calculate a transition probability between location sequences, quantify an impact of current query time on the spatiotemporal and semantic features of the generated candidate dummies, and screen the generated candidate dummies, such that a remaining dummy after the screening is capable of effectively protecting location privacy of the user.

Another objective of the present disclosure is to provide a computer device. The computer device includes a memory and a processor, where the memory stores a computer program, and the computer program is executed by the processor to perform the steps of the dummy-based privacy protection method based on semantic relevance of a movement path.

Another objective of the present disclosure is to provide a computer-readable storage medium, storing a computer program. The computer program is executed by a processor to perform the steps of the dummy-based privacy protection method based on semantic relevance of a movement path.

Another objective of the present disclosure is to provide an information data processing terminal. The information data processing terminal is configured to implement the dummy-based privacy protection system based on semantic relevance of a movement path.

1 Specific implementations of the present disclosure:
Existing dummy-based privacy protection schemes all fail to measure semantic relevance between location sequences of a real query of a user from a holistic perspective when the user continuously uses a location service. If these schemes are directly adopted for protecting location privacy of the user during continuous queries, an LSP can still utilize semantic relevance between location sequences in a movement path to identify some dummies and even directly identify a real location of the user, as shown in FIG. 3.

### 1.1 System Structure

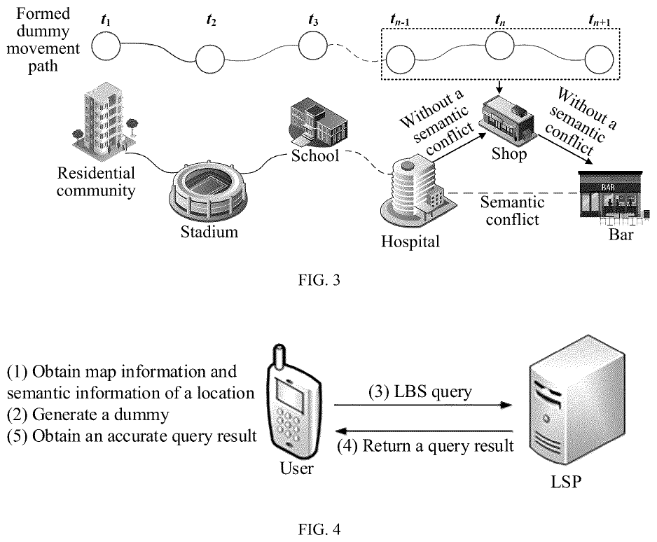

As shown in FIG. 4, the system structure adopted in this specification mainly consists of two parts: a user and an LSP. The LSP is a semi-trusted entity, and there is a reliable transmission channel between the user and the LSP.

When the user wants to send an LBS query request, the user first acquires map information of a current location and accesses a semantic location database, calculates a historical query probability of a map location and an inter-location transition probability by combining a historical movement path of the user, generates, based on quantity K of privacy protection demands of the user, a location set containing a real location of the user and K-1 dummies, and finally sends the generated locations, together with query content of the user, to the LSP. After receiving the query request sent by the user, the LSP performs retrieval in its database based on the query content and the location set, and returns retrieval results to the user. Upon receiving the query results returned by the LSP, the user screens the received query results based on a real location of the user to obtain an accurate query result.

### 1.2 Related Definitions

Below are some basic concepts used in this specification, including definitions of a user location and a historical semantic path of a user.

Definition 1: user location loc. The user location loc is a set consisting of coordinates and access time of a location, namely loc={(lat,lon),t}, where (lat,lon) represents the coordinates of the location; lat and Ion respectively represent latitude and longitude of the location; and t represents time when the user accesses the location.

In this specification, semantic type POI_t of any location is divided into the following three levels based on an Amap classification document:

$$( 1 ) major - level {POI\_t}_{c l a s s} = \{ p o {i}_{c l a s s}^{1} , po {i}_{c l a s s}^{2} , … {poi}_{c l a s s}^{{n}^{′}} \} ;$$

$$( 2 ) medium - level {POI\_t}_{div} = \{ p o {i}_{div}^{1} , {poi}_{div}^{2} , … , {poi}_{div}^{{n}^{″}} \} ; and$$

$$( 3 ) minor - level {POI\_t}_{s e c} = \{ p o {i}_{se c}^{1} , {poi}_{se c}^{2} , … , {poi}_{se c}^{{n}^{″}} \} .$$

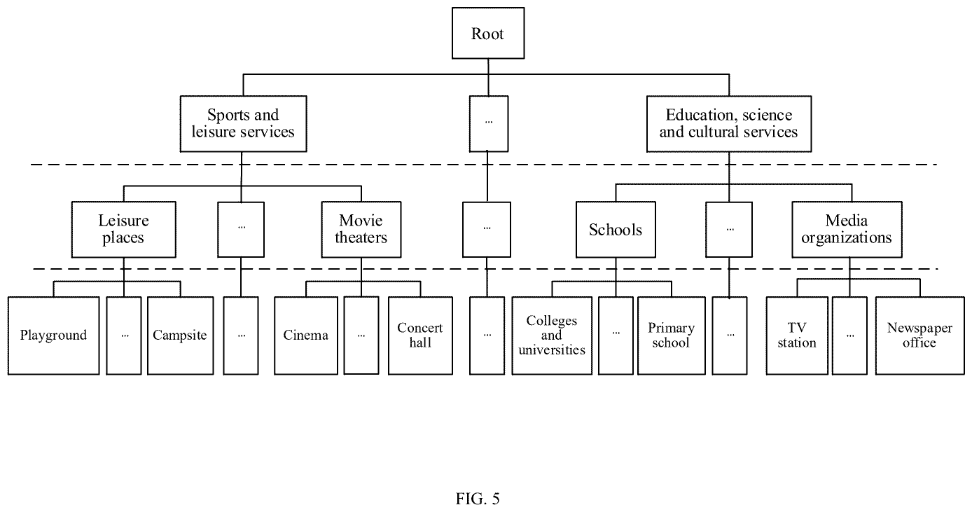

As described above, poiⁿ represents a detailed semantic location at a corresponding level. As shown in FIG. 5, medium-level POI_t_{dv}={schools} belongs to major-level

POI_t_{class}={education, science and cultural services}, and includes minor-level POI_t={colleges and universities, . . . , and primary schools}.

Definition 2: historical semantic path Traj of the user. A movement path formed by a real location sequence when user u sends an LBS query within a historical time period is referred to as one historical semantic path of the user, namely

$$Traj ( u ) = \{ {l}_{u}^{1} , {l}_{u}^{2} , {l}_{u}^{3} … {l}_{u}^{i} \} , where {l}_{u}^{i} = \{ {loc}_{u}^{i} , {POI\_t}_{u}^{i} \}$$

represents a location at which the user u sends an i^{th} LBS query on the movement path.

Furthermore, if a map is divided into ω×ω grids, the number of times that the user has sent the LBS query in each grid historically can be counted. Then, historical query probability qᵢ of the user in any grid can be calculated, namely:

$${q}_{i} = \frac{{num}_{i}}{{{\sum }_{i = 1}}^{{ω}^{2}} {num}_{i}} \qquad ( 1 )$$

where num, represents the number of times that the user sends a query in grid cell i historically. Obviously, a sum of historical query probabilities of the user across all grids is

$${\sum }_{i = 1}^{{n}^{2}} {q}_{i} = 1.$$

Similarly, inter-location transition probability Prᵢⱼ can be calculated according to the following formula:

$$P {r}_{i j} ( {l}_{i} \vert {l}_{j} ) = \frac{N ( {l}_{i} , {l}_{j} )}{T ( {l}_{i} )} \qquad ( 2 )$$

In the above formula, N(lᵢ,lⱼ) represents the number of times of moving from location lᵢ to location lⱼ; and T(lᵢ) represents the total number of times of moving out from the location lᵢ. When T(lᵢ)=0 (in other words, the location lᵢ does not appear on the path as a location before transition), Prᵢⱼ=0.

2 Scheme of this Specification

In an LBS scenario, when a dummy-based location privacy protection technology is used, it is essential to ensure that a generated dummy sequence is semantically indistinguishable from a real location sequence. Otherwise, an LSP can utilize semantic relevance between location sequences in a formed movement path to identify a dummy and even directly identify a real location of a user. However, existing dummy-based location privacy protection schemes do not consider the semantic relevance between the location sequences from a holistic perspective when generating the dummy. This specification uses a neural network to learn spatiotemporal and semantic features between locations on a real movement path of the user, combines a transition probability between the location sequences, and quantifies an impact of query time on the spatiotemporal and semantic features between the locations, thereby providing a dummy-based privacy protection scheme based on semantic relevance of a movement path.

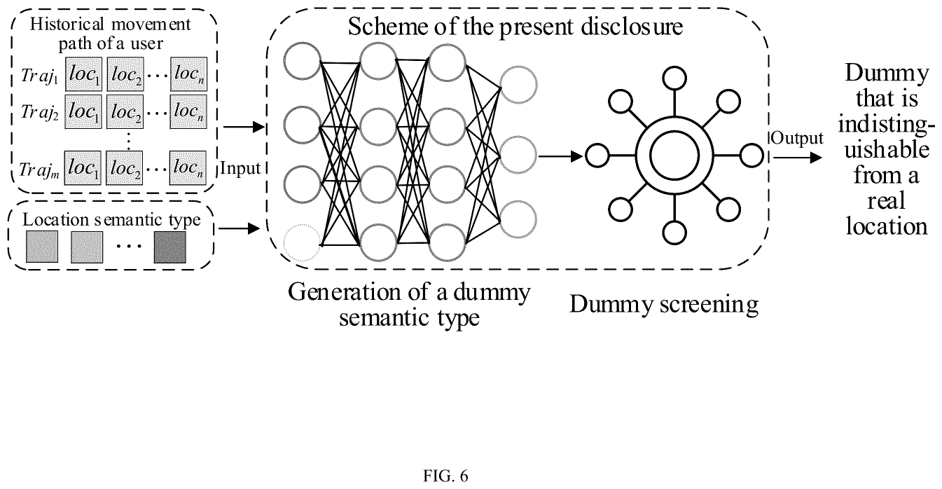

As shown in FIG. 6, this scheme of this specification consists of two parts: generation of a dummy semantic type and dummy screening. When the user wants to send an LBS request, dummy semantic type move_t ∈ POI_t_{dlv} that conforms to a feature of a movement path of the user is first generated by using the neural network based on a historical movement path. The dummy screening is to filter all dummies whose medium-level semantic types are move_t. Its basic idea is as follows: A dummy with a low transition probability from a historical location to this location is first eliminated, and a remaining dummy is taken as a candidate dummy. Then, the candidate dummy is scored based on the historical movement path Traj and location transition probability Prᵢⱼ of the user. The location transition probability Prᵢⱼ is calculated based on the historical movement path Traj. Probability Pr_{ab} that a location on a historical trajectory is transitioned to the candidate dummy is multiplied by corresponding time weight λₜ to obtain a transition score of the candidate dummy. A transition score from each location on the historical trajectory to the candidate dummy is calculated and accumulated to get total score score of the candidate dummy, and finally K-1 candidate dummies with a highest total score are selected as dummies submitted to the LSP.

### 2.1 Generation of the Dummy Semantic Type

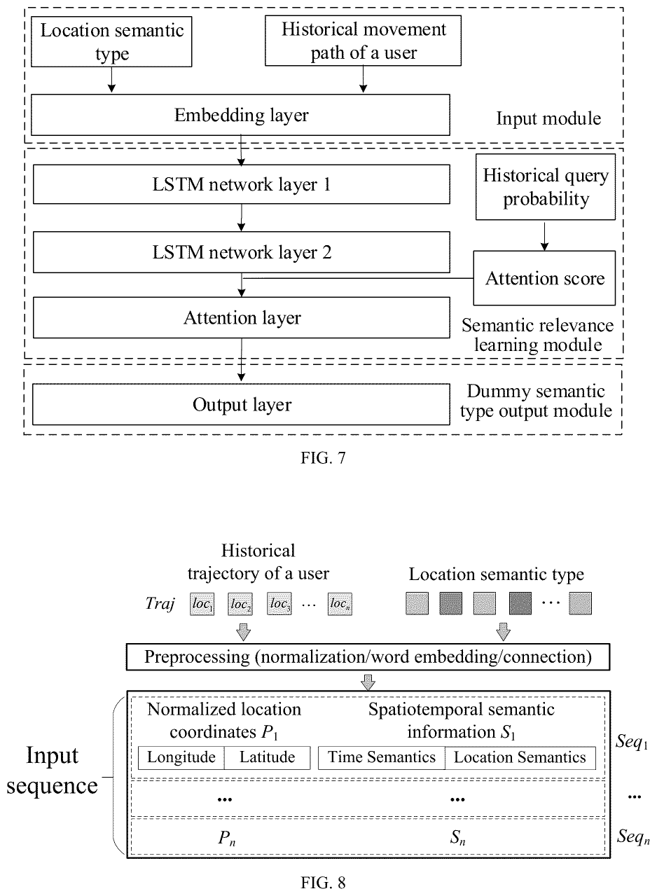

The generation of the dummy type mainly involves three modules: an input module, a semantic relevance learning module, and a dummy semantic type output module, as shown in FIG. 7. The input module primarily encodes and embeds a user path and each location type, thereby extracting temporal, spatial, and semantic information from the historical movement path of the user to generate an input sequence.

The semantic relevance learning module learns spatiotemporal relevance and semantic relevance between different locations on the historical movement path of the user. Based on features of the extracted spatiotemporal relevance and semantic relevance, the dummy semantic type output module generates a dummy semantic type that conforms to a feature of the real movement path of the user.

### 2.1.1 Input Module

The input module preprocesses an original input path of the user, and connects normalized latitude, longitude, access time, and semantic information of each location on the path to form the input sequence. Specifically, the latitude and the longitude of each location on the path are first normalized and then connected to form spatial location tensor e^{(lat,lon)} ∈ [symbol] ². Herein, [symbol] represents a real number space.

Since the movement path of the user is often periodic and regular in terms of time, this specification respectively maps specific day week of a week and time point day of a day into an n₁-dimensional vector and an n₂-dimensional vector, namely e^{week} ∈ [symbol] ⁿ^{₁} and e^{day}∈ [symbol] ⁿ^{₂}. This helps to learn weekly and daily periodic patterns of the user, thereby effectively depicting inter-location relevance in the movement path. Medium-level location semantic type POI_t_{div} is taken as a learning object for inter-location semantic relevance in the movement path. A location semantic of each location in the historical movement path is encoded using an integer by referring to Amap classification. Since this encoding form is discrete, a word embedding technology is adopted to embed the location semantics of various locations in the historical movement path into a form of a continuous numerical value, that is, an embedding of location semantics is denoted as e^{p}∈ [symbol] ⁿ^{₃}, where n₃ represents an embedding dimension. The word embedding technology can make semantically similar words closer in a vector space and better capture semantic relevance between the words. After the normalization and embedding operations, the input sequence e^{seq} is generated through the connection operation and then is input into the subsequent neural network for feature extraction and learning, namely

$${e}^{s e q} = {e}^{( lat , lon )} + {e}^{w e e k} + {e}^{d a y} + {e}^{p} ∈ {\text{?}}^{d} .$$

As described above, d represents a dimension of an embedding space, and a structure of an input layer is shown in FIG. 8.

### 2.1.2 Semantic Relevance Learning Module

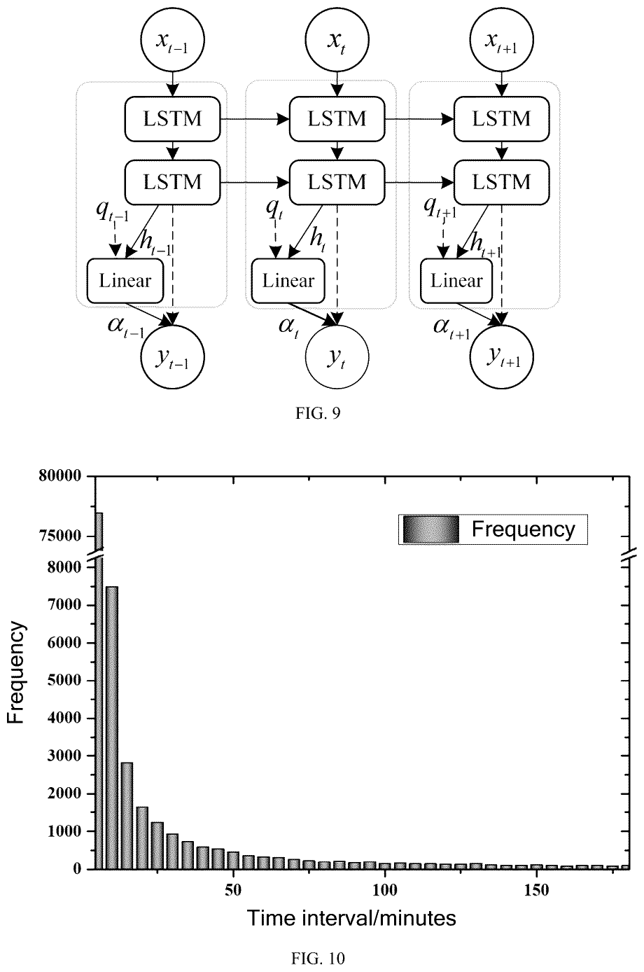

The semantic relevance learning module is configured to extract the feature of the real movement path of the user. The semantic relevance learning module consists of an LSTM network layer and an attention layer, as shown in FIG. 9.

In the LSTM network layer, based on an input location sequence, inter-location relevance in the location sequence is captured, and a hidden state sequence is generated and input into the attention layer. In the attention layer, the hidden state sequence output by the LSTM network layer is weighted through an attention mechanism to generate a weighted output sequence, thereby assigning different weights based on relevance between different locations.

### 1) LSTM Network Layer

Stacked LSTM networks are employed in this specification to better learn the inter-location relevance in the movement path of the user. The LSTM network is a special recurrent neural network (RNN), which is suitable for processing and predicting spatiotemporal sequence data. The network is composed of a series of LSTM units, including a forget gate, an input gate, a candidate cell state, a cell state, and an output gate, which are respectively denoted as fₛ, iₛ, \tilde{C}ₛ, Cₛ, and oₛ. Specifically,

$${f}_{s} = σ ( {W}_{f} \cdot [ {h}_{s - 1} , {x}_{s} + {b}_{f} ] ) ; \qquad ( 3 )$$

$${i}_{s} = σ ( {W}_{i} \cdot [ {h}_{s - 1} , {x}_{s} ] + {b}_{i} ) ; \qquad ( 4 )$$

$${\tilde{C}}_{s} = tanh ( {W}_{C} \cdot [ {h}_{s - 1} , {x}_{s} ] + {b}_{C} ) ; \qquad ( 5 )$$

$${C}_{s} = {f}_{s} ⊗ {C}_{s - 1} + {i}_{s} ⊗ {\tilde{C}}_{s} ; \qquad ( 6 )$$

$${o}_{s} = σ ( {W}_{o} \cdot [ {h}_{s - 1} , {x}_{s} ] + {b}_{o} ) ; \qquad ( 7 )$$

$${h}_{s} = {o}_{s} ⊗ tanh ( {C}_{s} ) . \qquad ( 8 )$$

As described above, hₛ represents a hidden state at time step s; σ represents an activation function; xₛ represents an input at the time step s; W_{f}, Wᵢ, W_{C}, and Wₒ respectively represent weights of the forget gate, the input gate, the candidate cell state, and the output gate; b_{f}, bᵢ, b_{C}, and bₒ respectively represent biases of the corresponding gates; and the symbol “⊗” represents element-wise multiplication.

### 2) Attention Layer

The attention layer can learn a weight on an output sequence of the LSTM network, thereby assigning attention to the hidden state hₛ at the time step s. The hidden state hₛ corresponding to each time point and output by the LSTM network is concatenated with normalized historical query probability qᵢ of a current location to calculate an attention score. The attention score is determined by the historical query probability qᵢ of a location. A larger value of the historical query probability qᵢ leads to a higher attention score, indicating that the location is a key location for predicting a user behavior; and vice versa. Attention score eₛ at the time step s can be calculated according to the following formula:

$${e}_{s} = Linear ( [ {h}_{s} , {q}_{i} ] ) ; \qquad ( 9 )$$

As described above, Linear(·) represents a linear function, which is defined as follows:

$$Linear ( x ) = w x + b , where \qquad ( 10 )$$

As described above, w and b respectively represent a weight matrix and bias vector.

Based on importance of different locations, the attention layer assigns a different attention weight to each time point in the output sequence of the LSTM network to output a weighted hidden state. The output serves as an input of the dummy semantic type output module, and a specific calculation method is as follows:

$${α}_{s} = σ ( {e}_{s} ) ; \qquad ( 11 )$$

$$A = {\sum }_{s = 1}^{L} {α}_{s} ⊗ {h}_{s} ; \qquad ( 12 )$$

As described above, as represents an attention weight of the time step s, A represents a weighted sequence output, and L represents a sequence length.

### 2.1.3 Output Module

### 1) Model Optimization

The output module is a fully-connected neural network consisting of two linear layers. A learned feature vector can be mapped into a smaller dimension and ultimately transformed into an output space that matches a task. Specific calculation formulas are as follows:

$${h}_{o u t} = {W}_{1} \cdot x + {b}_{1} ; \qquad ( 13 )$$

$$\hat{y} = {W}_{2} \cdot {h}_{out} + {b}_{2} ; \qquad ( 14 )$$

In the above formulas, hₒᵤₜ represents a hidden state of the output module, y represents a final output of a model, W₁ and W₂ respectively represent weight matrices of the linear layers fc₁ and fc₂, and b₁ and b₂ respectively represent bias vectors of the linear layers fc₁ and fC₂.

To optimize a prediction result, this specification adopts a mean squared error (MSE) as loss function

$$M S E = \frac{1}{n} {\sum }_{i = 1}^{n} ( {y}_{i} - {\hat{y}}_{i} ) ,$$

where yᵢ represents real data, and n represents a sample quantity. In addition, a stochastic gradient descent (SGD) algorithm is combined to optimize parameters in the model to minimize the loss function. The SGD algorithm is applicable to a large-scale dataset, and can significantly reduce a computational load and accelerate a training speed.

### 2) Model Output

This module calculates a similarity between the model output j and each location semantic poi ∈ POI_t_{div} in the historical movement path, and sorts the location semantic type based on the similarity; and then selects P location semantic embedding vectors that are closest to a predicted vector, thereby obtaining corresponding semantic labels

$$\{ p o {i}_{div}^{1} , p o {i}_{div}^{2} , … {poi}_{div}^{μ} \} .$$

Based on the above description, the following describes an algorithm for generating the dummy semantic type move_t.

Algorithm 1: algorithm for generating a predicted dummy semantic type

Input: model output ŷ, location semantic type set POI_t_{div} , and quantity μ of predicted
types
Output: predicted dummy semantic type move_t
1. obtain embedding vector set Embedding_set of the location semantic type POI_t_{div}
from an embedding layer;
2. calculate a similarity between the predicted vector ŷ and each embedding in the embedding
set Embedding_set of the location semantic type;
$3. sort the semantic labels \{ {poi}_{div}^{1} , {poi}_{div}^{2} , … {poi}_{div}^{μ} \} in the location semantic type set based on$
the similarity;
4. select the first μ semantic labels from a sorted index; and
5. return a predicted location semantic type label as the move_t.

### 2.2 Dummy Screening

Based on the generated dummy semantic type, this section designs a dummy generation scheme based on the transition probability. An impact of the transition probability gradually decreases over time, that is, a transition probability from location lᵢ to location lⱼ is affected by a time interval between the two locations. Therefore, this specification introduces the time weight λₜ to adjust an original transition probability, thereby more accurately describing a movement behavior of the user.

An actual transition probability from the historical location lᵢ to the current location lⱼ is as follows:

$${Pr}_{ij}^{′} = {λ}_{t} \cdot {Pr}_{ij} . \qquad ( 15 )$$

where λₜ represents a time weight determined by time interval Δt from access time tⱼ of the current location lⱼ to access time tᵢ of the historical location lᵢ; and Prᵢⱼ represents the original transition probability without distinguishing a time feature.

Furthermore, to ensure that the generated dummies are semantically indistinguishable, this scheme takes into account both an inter-location transition probability and a dynamic effect of a time dimension. In Section 2.2.1, a process of calculating a difference between location transition probability sets at different time intervals based on the movement path of the user, and determining a time weight of the location transition probability based on the difference to quantify an impact of time on state transition will be described in detail. A specific solution is to compare the location transition probability with original transition probability T_Prₜₒₜₐₗ without distinguishing the time interval, and screen location transition probability set

$${T\_Pr}_{time} = \{ {Pr}_{ij}^{n} {\vert}_{Δ t} \}$$

under time interval Δt between adjacent locations. A similarity between sets is used as a measurement basis for the time weight λₜ, and how to generate, based on the actual location transition probability

$${Pr}_{ij}^{′} ,$$

a dummy that conforms to semantic relevance of the movement path of the user will be elaborated in Section 2.2.2.

### 2.2.1 Calculating the Time Weight

Step 1. Based on historical movement path set Tra={Traj(u₁),Traj(u₂), . . . Traj(uₙ)} formed by real locations at which users send LBS requests historically, where Traj(uₙ) represents a trajectory of an nₜₕ user, the transition probability

$${T\_Pr}_{total} = \{ {Pr}_{total}^{1} , {Pr}_{total}^{2} , … , {Pr}_{total}^{n} \}$$

between the adjacent locations is calculated, where

$${Pr}_{total}^{n}$$

represents a specific value of the original transition probability. The transition probability can effectively describe a movement pattern of the user between different locations.

Step 2. Based on time distribution time_{gap} among location points in the statistical historical movement path set, different historical movement path set Tra′|_{Δt}={Traj′(u₁)|_{Δt}, . . . , Traj′(uₙ)|_{Δt}} is obtained through screening, such that each location on new historical movement path Traj′(uᵢ)|_{Δt} obtained through the screening satisfies the time interval Δt=time_{gap} between the adjacent locations.

Step 3. For the new historical movement path set Tra′|_{Δt} that is obtained through the screening, transition probability Pr|_{Δt} between adjacent location points in different sets is calculated and added to the location transition conditional probability set T_Prₜᵢₘₑ.

Step 4. The original location transition probability set T_Pₜₒₜₐₗ is compared with the location transition conditional probability set

$$\{ {T\_Pr}_{time}^{1} , {T\_Pr}_{time}^{2} … {T\_Pr}_{time}^{n} \}$$

at different time intervals Δt, the similarity between the sets is utilized to quantify the impact of the time on the transition probability, and the time weight λₜ is obtained:
(1) The location transition probability set T_Pr contains a plurality of key-value pairs. Each key-value pair element {[lₘ,lₙ,], Prₘₙ} represents location transition probability Prₘₙ from previous location transition state lₘ to next location transition state lₙ in a current set.
(2) An intersection of the original location transition probability set T_Prₜₒₜₐₗ and the location transition conditional probability set T_Prₜᵢₘₑ is found, namely common transition state [lₘ,lₙ] that is contained in the two sets, and difference diff between location transition probabilities Prₘₙ of the common transition state in the two sets is calculated. If probability values of a common element in the two sets are closer and the difference diff between the transition probabilities Prₘₙ is smaller, a similarity between the two sets is higher.
(3) An unique element in the original location transition probability set T_Prₜₒₜₐₗ and the location transition conditional probability set T_Prₜᵢₘₑ is found, namely transition state [lₘ,lₙ] that is contained only in one of the sets, and location transition probability Pr_{ab} of the transition state directly reflects the difference diff between the two sets.
(4) The similarity between the two sets is calculated based on the difference diff, and is converted into a percentage form as final time weight λₜ for the location transition probability. A specific calculation formula is as follows:

$${λ}_{t} = \frac{1 - diff}{total} \times 100 \qquad ( 16 )$$

Based on the above description, a specific time weight algorithm can be given, which is specifically as follows:

Algorithm 2: algorithm for determining the time weight

Input: original location transition probability set T_Prₜₒₜₐₗ, and location transition conditional
probability set T_Prₜᵢₘₑ
Output: time weight λₜ
1. obtain the common transition state [lₘ, lₙ] that is contained in the set T_Prₜₒₜₐₗ and the set
T_Prₜᵢₘₑ;
2. calculate an absolute value of a difference between probabilities Prₘₙ of each common
transition state, and sum the absolute value to the difference diff;
3. acquire a value of a unique transition state in each set, and sum the value to the difference
diff;
4. calculate total quantity total of all key-value pairs in the two sets;
$5. calculate the similarity between the two sets , which is denoted as {similar}_{t} = \frac{1 - {diff}_{t}}{total} ; and$
6. obtain the time weight, namely λₜ = similarₜ ×100.

2.2.2 Generation of the Dummy

Based on the algorithm for determining the time weight for the location transition probability, the following describes a process of generating the dummy in detail.

Firstly, based on μ predicted dummy semantic types move t at a query time point in Section 2.1.3, all locations locₚₒᵢ∈ POI_t_{sec} whose medium-level semantic types are move_t are acquired from the location semantic type set Poi_set as candidate dummies, and whether each location locₚₒᵢ is semantically rational is evaluated. A specific process of this algorithm is as follows.

Step 1. All obtained locations

$${loc}_{poi}^{i}$$

are screened, such that the candidate dummies meet a condition that transition probabilities Prᵢⱼ from the historical location lᵢ to the

$${loc}_{poi}^{i}$$

are all greater than transition probability screening threshold εᵤ. The transition probability screening threshold εᵤ is not a fixed constant. Instead, it is determined by elements in transition probability set Prᵢⱼ(lᵢ|·) of locations lᵢ on different historical trajectories, and is affected by time. A calculation formula of the transition probability screening threshold is as follows:

$${\hat{ε}}_{u} = {ε}_{u} \cdot Gen ( Δ t ) \qquad ( 17 )$$

where Gen(·) represents a function that decays as the time interval Δt increases, and \hat{ε} represents a dynamic screening threshold that decreases as the time interval Δt increases.

Step 2. A transition score of a candidate dummy is a product of probability Prᵢⱼ of transition from the historical location lᵢ to the candidate dummy and corresponding time weight λₜ. A transition score from each historical location to the candidate dummy is calculated and accumulated to get total score score of the candidate dummy. All the candidate dummies

$$\{ {loc}_{poi}^{1} , {loc}_{poi}^{2} , … , {loc}_{poi}^{n} \}$$

are sorted in a descending order based on their scores, and K-1 dummies with a highest score are output as an anonymity set.

A specific algorithm for generating the dummy is as follows:

Algorithm 3: algorithm for generating the dummy

Input: current time t_{current} for sending an LBS query; dummy semantic type set Move_t;
quantity K of privacy protection demands of the user; historical movement path Traj of
the user; location semantic type set Poi_set, and dynamic screening threshold \hat{ε}.
Output: dummy locₚₒᵢ
1. calculate time difference Δt = t_{current} − tᵢ between the current query time and access time
of a location point on the historical movement path; t_{current}-tᵢ
2. acquire the weight λₜ based on the time difference Δt;
$3. from the location semantic type set Poi\_set , acquire each dummy {loc}_{poi}^{j} whose$
medium-level semantic type is Move_t and that meets a condition that a transition
probability from a point on the path to the dummy is greater than the threshold ε as the
candidate dummy.
$4. calculate a score of each candidate dummy {loc}_{poi}^{j} relative to each historical location$
$point and accumulate the score according to score\_dict [ {loc}_{poi}^{j} ] = {\sum }_{j = 1}^{n} {pro}_{total}^{ij} * {λ}_{t} * 100 ;$
5. if a quantity of candidate dummies that meet a screening condition is greater than K,
sort the candidate dummies in the descending order based on their scores;
6. otherwise, randomly generate another location semantic type POI_type_{div} that has a
same major-level semantic type as the Move_t, and acquire a dummy whose medium-
level semantic type is the random semantic type;
7. repeat the steps 6 to 8;
8. if dummies of all random semantic types fail to meet the privacy protection demands
of the user;
9. anonymization failed; and
10. otherwise, output the first K candidate dummies locₚₒᵢ with a highest score as
dummies to form the anonymity set.

### 3.1. Safety Analysis

It is assumed that an attacker attempts to filter the generated dummies based on semantic information of each location point in path information

$$Traj ( u ) = \{ {l}_{u}^{1} , {l}_{u}^{1} , … , {l}_{u}^{n} \}$$

of the user. After the dummy generation scheme proposed in this specification is adopted, if εᵤ>εₐ, it is difficult for the attacker to infer the dummies based on the inter-location transition probability after receiving a submitted location set. Herein, εᵤ represents the transition probability screening threshold, and Eₐ represents a transition probability screening threshold of the attacker.

If the attacker wants to filter the dummies based on path rationality of the user, the attacker needs to determine whether a location point on the historical movement path of the user and a point in the submitted location set set satisfy the following condition:

$${Pr}_{ij} ( {l}_{i}^{( traj )} , {l}_{j}^{( set )} ) > {ε}_{a}$$

If the attacker successfully identifies an unreasonable dummy, the following condition is met:

$${Pr}_{ij} ( {l}_{i}^{( traj )} , {l}_{j}^{( set )} ) < {ε}_{a}$$

As can be seen from the algorithm

$${ε}_{u} < {Pr}_{ij} ( {l}_{i}^{( traj )} , {l}_{j}^{( set )} ) .$$

### Therefore:

εᵤ<εₐ is true, which obviously contradicts the known εᵤ>εₐ. Therefore, if εᵤ>εₐ, the attacker is unable to filter out the unreasonable dummy based on the location transition probability. For the submitted set containing K locations, a probability that the attacker identifies the real location of the user is K. Therefore, this algorithm can effectively prevent the attacker from inferring the real location of the user based on background knowledge and collected user information, thus protecting location privacy of the user.

### 3.2 Time Complexity Analysis

This section will analyze time complexity of two models in this scheme of this specification.

For an LSTM network model, time complexity during data loading and preprocessing depends on a size of input data. Time complexity of data normalization and other data preprocessing processes is usually O(1). Therefore, if a quantity of input data points is N, time complexity of this part is O(N). Time complexity of the LSTM network layer mainly depends on the sequence length T, size H of the hidden layer, size I of an input dimension, and quantity L of LSTM layers. At each time step, the LSTM network needs to multiply the weight matrix and an input and multiply weight matrices of a previous hidden state and a current state. Therefore, time complexity of each time step is O(IH+H²), and time complexity of the entire sequence is O(T·(IH+H²)). Since a two-layer LSTM structure is used, calculation is performed once for each layer, and time complexity of the two-layer network model is O(2T·(IH+H²)).

Based on the above analysis, time complexity of a dummy semantic type prediction model is mainly determined by forward propagation of the LSTM model, that is, the time complexity of the dummy semantic type prediction model is O(2T·(IH+H²)).

After receiving the predicted P dummy semantic types of the user, a dummy generation module first reads the POI set Poi_set and then searches for a corresponding dummy based on a generated dummy semantic type, which can be usually regarded as constant time O(1). After the dummy is selected, it is necessary to traverse historical movement path data of the user, check location transition probabilities of each location point and the dummy, and calculate a score of each location. Assuming that a size of the transition probability set is M, time complexity required for generating the transition probability set is O(MIN). Subsequently, each location needs to be sorted in the descending order based on its score, and time complexity required for sorting in the descending order based on its score is O((K-1)log(K-1)). Herein, K represents the quantity of privacy protection demands of the user.

In a best case, K-1 valid dummies can be found through a single calculation. Therefore, best time complexity of the algorithm is O(MN+(K-1)log(K-1)). In a worst case, the user needs to perform a plurality of iterations to obtain sufficient valid dummies. It is assumed that there are W other semantic types that belong to a same major level as the generated semantic type. That is, in the worst case, W iterations are required. Therefore, worst time complexity is O(W(MN+(K-1)log(K-1)).

In order to verify effectiveness of the proposed dummy-based privacy protection scheme based on semantic relevance of a movement path in this specification through an experiment, the Geolife dataset [34-35] from Microsoft Research Asia is selected as experimental data in this specification. This dataset records 17,621 movement paths of 182 users over a period of 5 years (from April 2007 to August 2012), with a total distance of approximately 1.2 million kilometers and total duration of 50,176 hours. The experiment selects a most densely populated region in the dataset, which is a central region of Beijing, with a latitude range of [39.8, 40.0] and a longitude range of [116.2, 116.5]. This region is divided into 100×100 rectangular grids, and each grid is represented by coordinates of its center point. Semantic information of each grid is obtained by calling a reverse geocoding application programming interface (API) of Amap. For convenience of the experiment, the movement paths of the users in this dataset are preprocessed by using a time interval of 5 minutes as a standard. After the above processing, time intervals for movement between adjacent locations in the paths are mostly concentrated within a range of 5 minutes to 25 minutes, as shown in FIG. 10. Other parameters set for the experiment are shown in Table 1. A programming language used in the experiment is Python 3.8, an operating system is Windows 10-64 bit, and a hardware environment is AMD Ryzen 3 2200U with Radeon Vega Mobile Graphics (4 CPUs) and ~2.5 GHz 8192 MB RAM.

TABLE 1
Default parameters for the experiment

| Parameter | Default value |
|---|---|
| k | 5 |
| μ | 3 |
| ε | 50 (median) |

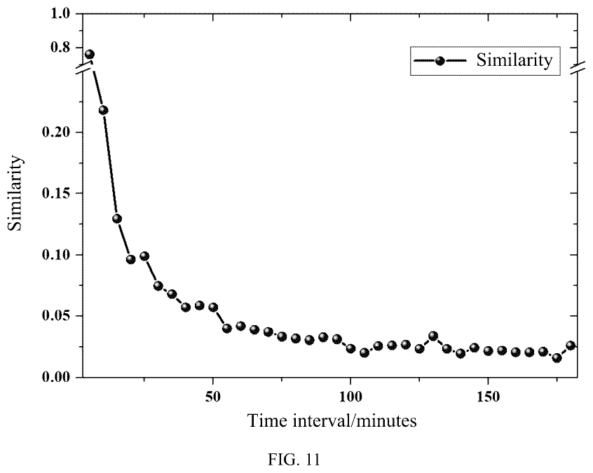

According to the algorithm in 2.2.1, similarities of the location transition probability sets at the different time intervals are calculated. As shown in FIG. 11, when Δt 180 min, as the time interval increases, similarities between the transition probability sets at the different time intervals and a location transition probability set without considering time gradually decrease, which conforms to a rule that the impact of the location transition probability weakens over time. To facilitate the calculation, this specification calculates a similarity range as a reference range for a weight value, as shown in Table 2.

TABLE 2
Time weight

| Time interval Δt | Weight λₜ |
|---|---|
| Δt ≤ 5 | 75 |
| 5 < Δt ≤ 10 | 21 |
| 10 < Δt ≤ 25 | 10 |
| 25 < Δt ≤ 50 | 5 |
| 50 < Δt ≤ 95 | 3 |
| 95 < Δt ≤ 180 | 2 |
| 180 < Δt ≤ 335 | 1 |

### 4.1. Model Training Process Analysis

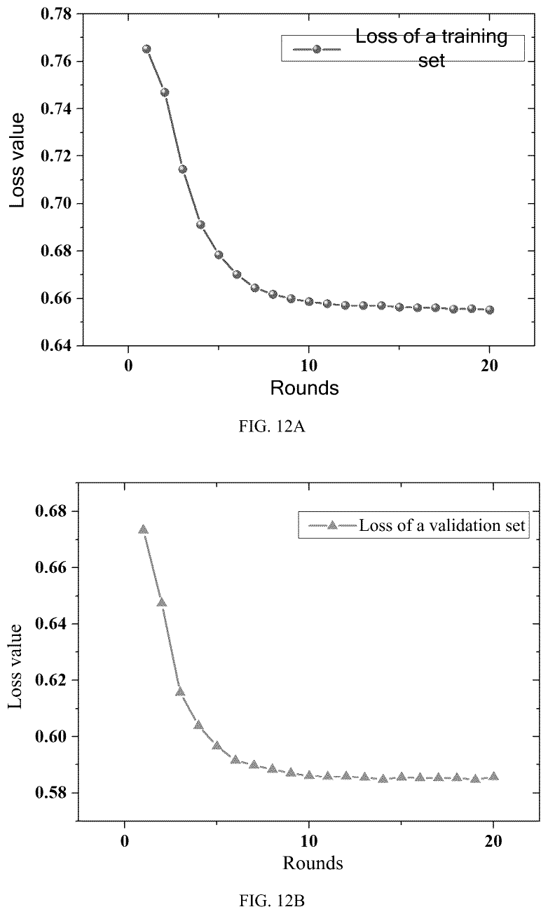

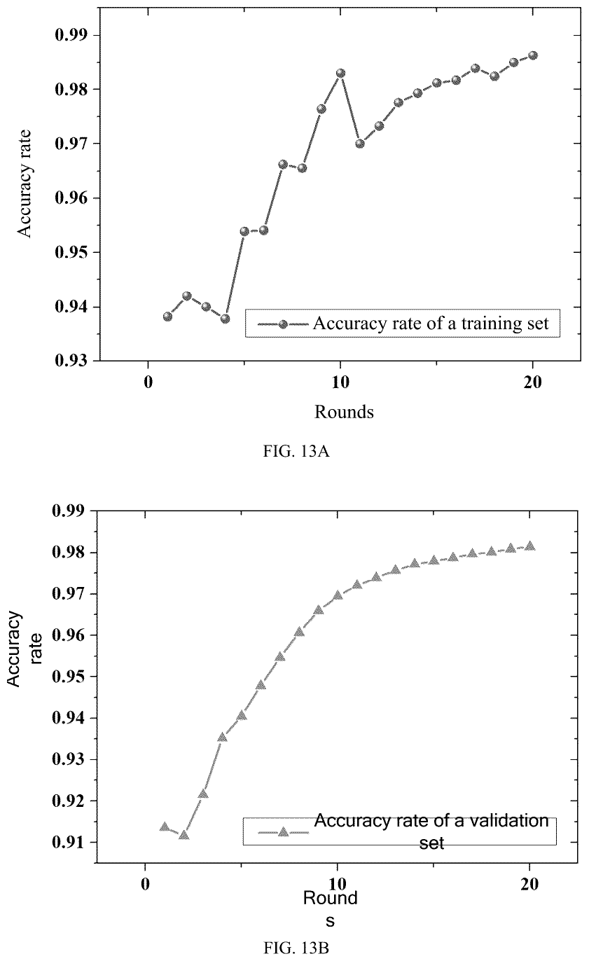

In this specification, in a training process of a neural network model, dimensions n₁ and n₂ are set to 3 and 6, and a semantic embedding is set to a 10-dimensional continuous vector. A dataset is divided into a training set (70%) and a test set (20%). The training set is iterated for 20 times. Model parameters are optimized using the SGD algorithm, with a learning rate of 0.01 and a batch size of 128. In the training process, a loss is shown in FIGS. 12A and 12B, and an accuracy rate is shown in FIGS. 13A and 13B. An optimizer calculates a loss value and updates the model parameters through backpropagation until the model converges. Therefore, as the number of training times increases, the model parameters are gradually optimized, the loss value gradually decreases, model performance is gradually enhanced, and the accuracy rate also rises accordingly. After a 10^{th} iteration, the model begins to converge, and change amplitudes of loss values of the training set and the validation set become less significant. Due to a significant difference between frequencies of appearing various location semantics in the path, sample imbalance results in a fluctuation in the accuracy rate of the training set.

### 4.2 Anonymization Success Rate

Since the μ and the ε are unique parameters, a variable control method is employed to set all other parameters to default values as shown in Table 1. Impacts of the quantity K of privacy protection demands, the quantity μ of dummy semantic types, and the location transition probability screening threshold ε on the anonymization success rate of this scheme are separately discussed.

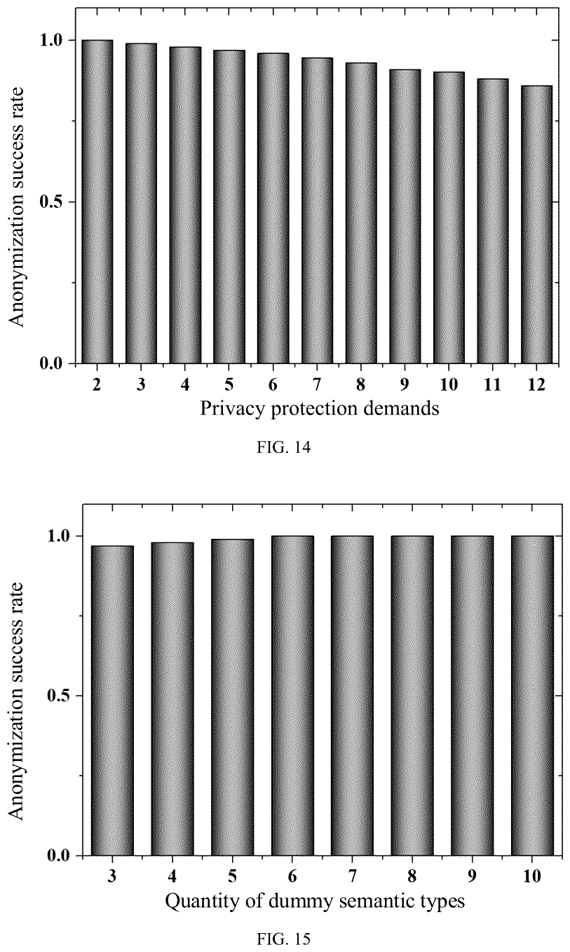

As shown in FIG. 14, as the quantity K of privacy protection demands of the user increases, the anonymization success rate decreases. This is because a quantity of dummies that satisfy semantic relevance gradually fails to meet a demand of the user.

As shown in FIG. 15, an increase in the quantity μ of the generated dummy semantic types leads to an increase in the anonymization success rate. This is because a larger value of the quantity μ of the generated dummy semantic types leads to more locations acquired and more dummies that meet a condition.

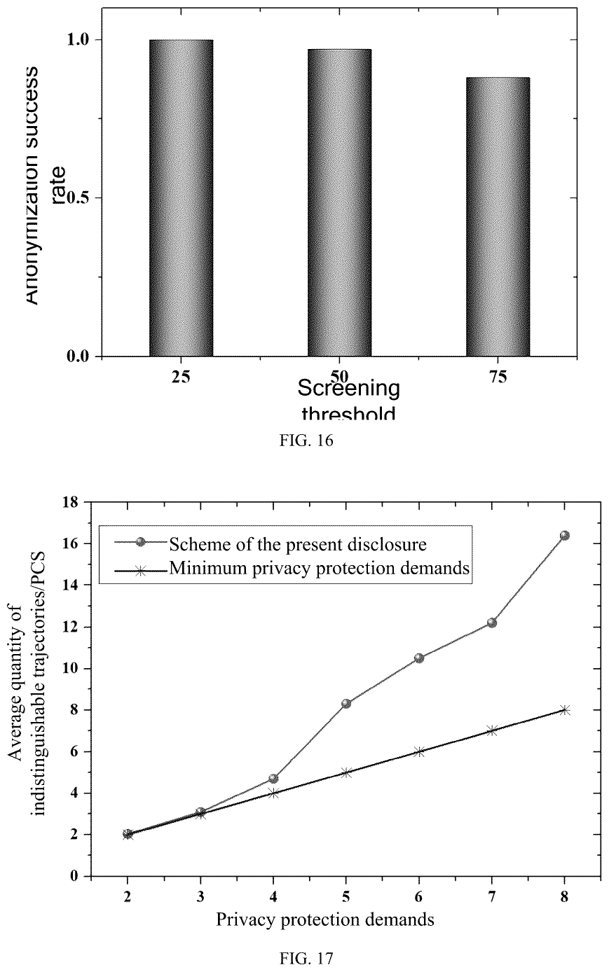

The screening threshold ε is determined by probability set Prᵢⱼ (lᵢ|·)={Pr₁, Pr₂, . . . , Prₙ} of transition from different locations to any other location. As shown in FIG. 16, a screening threshold for each location point is a 25th quantile, a median, and a 75th quantile of elements in a transition probability set of the location point. As the screening threshold increases, locations that meet a screening condition gradually decrease, and a success rate of this scheme in generating a reasonable dummy also decreases.

Overall, location semantics of the generated dummies is derived from a prediction of the neural network and is in line with semantic and temporal-spatial relevance. In addition, it is verified in Section 4.1 that performance of the LSTM network is excellent. Therefore, there are many locations that meet the inter-location transition probability. This makes this scheme have a high anonymization success rate in different scenarios.

### 4.3 Path Anonymization Success Rate

In a scenario of continuously sending LBS queries, the attacker acquires a collection of anonymous locations at different time points. Therefore, this section mainly verifies whether the path formed by the dummy sets generated by this scheme meets the quantity K of privacy protection demands of the user.

For a location set submitted at an n^{th} time point, each set contains m locations, which can form mⁿ paths. When the user has K privacy protection demands, at least K-1 paths that cannot be identified by the attacker need to be formed. Therefore, in order to verify the effectiveness of this scheme, this section conducts experiments under different values of the K to calculate a quantity of indistinguishable paths that can be formed by the generated dummy sets.

As shown in FIG. 17, for different values of the quantity K of privacy protection demands of the user, a quantity of formed paths that meet a location transition condition in the path is greater than the quantity K of privacy protection demands. Therefore, this scheme can effectively prevent the attacker from filtering the dummy based on the background knowledge and the location transition probability to reduce a privacy protection effect.

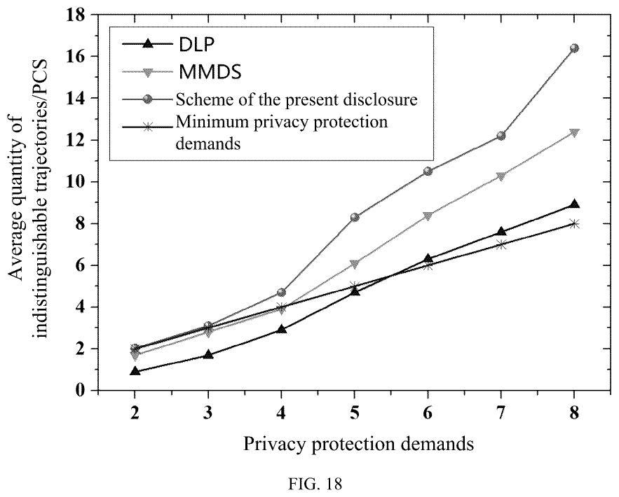

Furthermore, this scheme is compared with a dummy location privacy-preserving (DLP) algorithm and a Maximum and Minimum Dummy Selection (MMDS) algorithm. As shown in FIG. 18, a smallest quantity of indistinguishable paths are formed by dummy sets generated by the DLP algorithm, and most of them do not meet the privacy protection demand. This is because the DLP algorithm does not take into account an impact of a semantic factor when generating the dummy, only considering an edge information attack based on a query probability. However, the MMDS algorithm considers both the location semantics and the query probability, but the MMDS algorithm does not involve the location transition probability.

### 4.4 Calculation Overhead Analysis

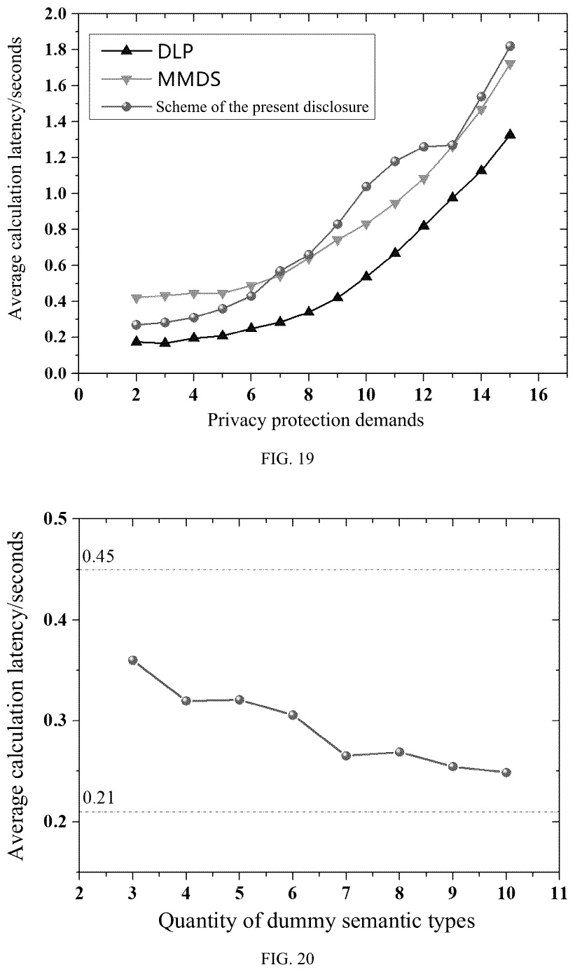

For different values of the quantity K of privacy protection demands of the user, this specification conducts repeated experiments by selecting different algorithms to verify generation efficiency of this scheme. As shown in FIG. 19, with an increasing demand for the privacy protection, average calculation latencies of different algorithms are all increasing. Since the DLP algorithm does not take into account a semantic feature of a location, an average latency required by the DLP algorithm to generate a location set is relatively small. In contrast, an average calculation latency of the MMDS algorithm is relatively close to that of this scheme, because these two schemes both need to perform dataset traversal and screening. When K>6, as the quantity K of privacy protection demands of the user increases, the user needs to expand a scope continuously and further select more dummies that meet a requirement, which leads to a relatively high average calculation latency for this scheme. However, an overall calculation latency of this scheme is within an acceptable range for the user.

This experiment will study an impact of the quantity μ of dummy semantic types on efficiency of generating the dummy. As shown in FIG. 20, as the quantity μ of dummy semantic types increases, the average calculation latency of the algorithm decreases. This is because when a value of the quantity μ of dummy semantic types is larger, more dummies are contained, more dummies meet a transition rule, and the efficiency of generating the dummy is higher.

When generating a dummy, existing dummy-based location privacy protection schemes do not consider semantic relevance between location sequences of a real query from a holistic perspective when a requesting user continuously uses the service. If these schemes are directly adopted for protecting location privacy of the user, after constructing a movement path based on a received location set, an LSP can still utilize semantic relevance between location sequences in the constructed movement path to identify a dummy and even directly identify a real location of the user. Therefore, the existing dummy-based privacy protection schemes cannot effectively protect location privacy of the user. To address this problem, this specification proposes a dummy-based privacy protection scheme based on semantic relevance of a movement path. This scheme first utilizes an LSTM network to extract spatiotemporal and semantic features between real location sequences of the user, and based on this, generates candidate dummies. Then, this scheme takes a historical movement path of the user as a reference, quantifies an impact of current query time on spatiotemporal and semantic features of a location, and screens the generated candidate dummies, such that a remaining dummy can effectively protect the location privacy of the user.

Specific application fields or related products of the present disclosure:
With the widespread use of smart devices and the development of mobile Internet, the LBS, as a mobile Internet service, has become very popular in people's daily lives. The LBS has demonstrated significant creative and application value in a plurality of fields, and its typical applications include information retrieval, navigation, advertising push, movement detection, and other services. For example, in real-time traffic navigation, tourism, and city tour scenarios, a navigation system using an LBS technology can provide real-time traffic information, helping the user avoid congestion, select a best route, and dynamically adjust a navigation path based on traffic conditions. For instance, both Amap and Google Maps can update traffic conditions in real time, provide route suggestions, and estimate arrival time. Location-based applications can also offer personalized travel recommendations and navigation services. Tourists can obtain information about nearby attractions, restaurants, and accommodations through the applications, and create travel plans based on their interests, thus achieving a more efficient travel experience. Therefore, when the LBS is used, a large number of dummies that are indistinguishable from the real location of the user, along with the real location of the user, are submitted to the LSP. This can effectively protect the location privacy of the user and enable the user to obtain an accurate query result.

It should be noted that the implementations of the present disclosure may be implemented by hardware, software, or a combination of software and hardware. The hardware part may be implemented using special logic. The software part may be stored in a memory and executed by a suitable instruction execution system, such as a microprocessor or specially designed hardware. Those of ordinary skill in the art can understand that the device and method described above may be implemented through computer-executable instructions and/or embodied in processor control code, and such code is provided, for example, on a carrier medium such as a disk, a compact disc (CD), or a digital video disc (DVD)-read-only memory (ROM), a programmable memory such as a ROM (firmware), or a data carrier such as an optical or electronic signal carrier. The device of the present disclosure and its modules may be implemented by hardware circuits such as very large-scale integrated circuits (VLSI) or gate arrays, semiconductors such as logic chips and transistors, or programmable hardware devices such as field programmable gate arrays and programmable logic devices, or by software executed by various types of processors, or by a combination of the above-mentioned hardware circuits and software, such as firmware.

The foregoing are merely descriptions of the specific implementations of the present disclosure, and the protection scope of the present disclosure is not limited thereto. Any modification, equivalent replacement, improvement, and the like made within the technical scope of the present disclosure by those skilled in the art according to the spirit and principle of the present disclosure shall fall within the protection scope of the present disclosure.

1. A dummy-based privacy protection method based on semantic relevance of a movement path, comprising following steps:
step 1, extracting spatiotemporal and semantic features of each location sequence in the movement path of a user by using a long short-term memory (LSTM) network, introducing an attention mechanism to assign different weights to various inter-location relevance in a real location sequence of the user, and generating candidate dummies that have same spatiotemporal and semantic features as the real location sequence of the user; and
step 2, taking a historical movement path of the user as a reference; calculating a transition probability between location sequences; quantifying an impact of current query time on the spatiotemporal and semantic features of the generated candidate dummies based on a similarity between inter-location transition probabilities under different time intervals Δt, wherein a higher similarity indicates that a location on the historical movement path has a greater impact on the spatiotemporal and semantic features of the candidate dummies, and conversely, a lower similarity leads to a smaller impact; and when screening the generated candidate dummies, adjusting a weight of an influencing factor based on the different time intervals, such that a remaining dummy after the screening is capable of effectively protecting location privacy of the user;
wherein the generating the candidate dummies that have the same spatiotemporal and semantic features as the real location sequence of the user comprises:
(1) enabling the generated dummies to be consistent with a real location of the user in terms of relevance to the location sequence; and
(2) ensuring that there is a high probability of transition from a historical location point on the historical movement trajectory of the user to each of the generated dummies;
wherein a method for the screening is as follows:
first determining a dynamic location transition probability screening threshold, wherein the threshold is determined by elements in a transition probability set of a different location when the different location serves as a semantic state before the transition, the threshold is a percentile of the set and is affected by a time factor, wherein a longer time interval between two location points leads to a smaller value of the threshold, and probabilities of transition from each point on the historical movement path of the user to the candidate dummies all need to be greater than the dynamic threshold; scoring all the candidate locations based on a historical transition probability;
and finally outputting top K-1 dummies with a highest score.

2. A dummy-based privacy protection system based on semantic relevance of a movement path for implementing the dummy-based privacy protection method based on semantic relevance of the movement path according to claim 1, wherein the dummy-based privacy protection system based on semantic relevance of the movement path comprises:
a generation module configured to extract the spatiotemporal and semantic features of each location sequence in the movement path of the user by using the LSTM network, introduce the attention mechanism to assign different weights to various inter-location relevance in the real location sequence of the user, and generate the candidate dummies that have the same spatiotemporal and semantic features as the real location sequence of the user; and
a screening module configured to take the historical movement path of the user as the reference, calculate the transition probability between the location sequences, quantify the impact of current query time on the spatiotemporal and semantic features of the generated candidate dummies, and screen the generated candidate dummies, such that the remaining dummy after the screening is capable of effectively protecting location privacy of the user.

3. A computer device, comprising a memory and a processor, wherein the memory stores the computer program, and the computer program is executed by the processor to perform steps of the dummy-based privacy protection method based on semantic relevance of the movement path according to claim 1.

4. A computer-readable storage medium, storing a computer program, wherein the computer program is executed by a processor to perform steps of the dummy-based privacy protection method based on semantic relevance of the movement path according to claim 1.

5. An information data processing terminal, wherein the information data processing terminal is configured to implement the dummy-based privacy protection system based on semantic relevance of the movement path according to claim 2.
